(19) United States
(12) Patent Application Publication
(10) Pub. No.: US 2006/0008064 A1
(43) Pub. Date: Jan. 12, 2006

(54) Flexible traffic rating interworking

(76) Inventor: Michael Sangillo, Bethesda, MD (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 10/887,198

(22) Filed: Jul. 8, 2004

(51) Int. Cl. H04M 15/00

(52) U.S. Cl. 379/114.08; 379/114.06

(57) ABSTRACT

A packet inspection system is provided with data inspection logic for inspecting subscriber packet traffic. The system includes a pre-rating classification table associated with the data inspection logic. The pre-rating classification table includes a table having one or more entry for static or slowly changing rating aspects of traffic applications and/or one or more entries identifying a dynamic changing rating aspects of a traffic application. A server with a rating engine is also provided. The data inspection logic makes a query to the pre-rating table as to the treatment of rating aspects of traffic applications and either obtains a rate value from the pre-rating classification table from one of the table entries for static or slowly changing rating aspects of traffic applications or obtains an indication from the one or more entry identifying a dynamic changing rating aspects of traffic applications directing the data inspection logic to query the rating engine, the data inspection logic then querying the server as to dynamic changing rating aspects of traffic applications and the server providing the data inspection logic with a correct valuation for the dynamic changing rating aspects of traffic applications.

### FIELD OF THE INVENTION

The invention relates generally to billing procedures for telecommunications applications or data content and services applications such as high volume call processing, real-time rating and decrementation of stored value for prepaid services, billing systems for postpaid telecommunications relating to applications including prepaid voice and data services for GSM/GPRS, CDMA/1×RTT and 3G wireless carriers, Wi Fi, Short Message Service (SMS—cellular phone text messaging) and MMS services, mobile content and Internet access, prepaid long distance and dial tone services, VOIP calls and other stored value transactions.

### BACKGROUND OF THE INVENTION

The procedure in which telecomunication data inspection systems determine what the provider has previously decided something should cost to applications including prepaid voice and data services for GSM/GPRS, CDMA/1×RTT and 3G wireless carriers, Wi Fi, Short Message Service (SMS—cellular phone text messaging) and MMS services, mobile content and Internet access, prepaid long distance and dial tone services, VOIP calls and other stored value transactions is generally referred to as rating. Charging centers have rating engines that work with charges including non-recurring, recurring and usage. Startup and cancellation fees are non-recurring charges, whereas cycle and multi-cycle fees (e.g. monthly, quarterly, etc.) are recurring. Usage charges are determined based on user activity, and can be either fixed or variable, depending on length of session, volume of download.

With the emergence of new services increasingly complex billing issues arise. Mobile applications, such as MMS, and content downloading are becoming popular as well as multimedia messaging and JAVA games. Service packages often have flexible pricing structures and certain content services must be rated according to a number of different parameters based on such parameters as events, data volume, session duration, location or quality of service. Prepaid services, whereby the subscriber pays for service usage in real-time, or near real-time, by spending funds deposited in advance into a prepaid account, form a significant percentage of the operator's user base. However, they bring extra complexity to the operator's network in terms of service status management. By offering prepaid services, the operator may charge for packet-switched access in real-time and without any credit issues. As an example, chargeable Packet Data Protocol (PDP) context in both 2.5G and 3G may be monitored in real-time. The protocol used in the interface between the IN platform and the Serving GPRS Support Node (SGSN) is the packed-switched specific subset of the CAP3.

Existing data plane content rating systems fall into two general classes. One class are those products, including earlier versions of the Megisto Systems Inc, Mobile Services Delivery System (MSDS), that examine content and rate it strictly according to tables/rules configured on the data plane component. These solutions work well for content whose value rarely changes. Another class of data plane content rating systems examines every piece of content and asks a full power Business Support System (BSS) rating engine for the rate for each piece of content. These products are extremely powerful and flexible, but they put a tremendous control load on the network and the BSS.

### SUMMARY OF THE INVENTION

It is an object of the invention to provide a packet inspection system that inspects subscriber packet traffic and rates it according to tables/rules configured on the data plane component and also uses a remote rating engine upon identifying dynamic changing rating aspects of traffic application without a tremendous control load on the network and the Business Support System (BSS).

According to the invention, a packet inspection system is provided with data inspection logic for inspecting subscriber packet traffic. The system includes a pre-rating classification table associated with the data inspection logic. The pre-rating classification table includes a table having one or more entry for static or slowly changing rating aspects of traffic applications and/or one or more entries identifying a dynamic changing rating aspects of a traffic application. A server with a rating engine is also provided. The data inspection logic makes a query to the pre-rating table as to the treatment of rating aspects of traffic applications and either obtains a rate value from the pre-rating classification table from one of the table entries for static or slowly changing rating aspects of traffic applications or obtains an indication from the one or more entry identifying a dynamic changing rating aspects of traffic applications directing the data inspection logic to query the rating engine, the data inspection logic then querying the server as to dynamic changing rating aspects of traffic applications and the server providing the data inspection logic with a correct valuation for the dynamic changing rating aspects of traffic applications.

The server with a rating engine may be a Remote Authentication Dial-In User Server (RADIUS).

The data inspection logic query may include providing subscriber status data to the server. The rate value may depend on one or more of time of subscriber use, subscriber roaming state and a service package assigned to the subscriber. Periodically or as needed, the packet inspection system replaces table entries with new or updated table entries.

The rating engine may be a rating and balance engine. Upon receiving a query from the data inspection logic, the rating and balance engine determines whether or not the subscriber is permitted to access the activity. The rating and balance engine may consider whether or not the subscriber has a balance of credit wherein the rating and balance engine returns a reservation of credit to the data inspection logic to charge the activity against and at the end of the activity the data inspection logic notifies the rating and balance engine of the successful completion of the service and an indication of an amount of the reserve that the subscriber's balance must be adjusted by.

The data inspection logic may be formed by one or more processors connected to the subscriber traffic by one or more switch. The data inspection logic is at a first location with the one or more processors and the one or more switch and the server with a rating engine at a remote location. The server may be connected to the one or more processors and the one or more switch via the router.

According to another aspect of the invention, a packet inspection method is provided. The method includes providing a data inspection logic entity and inspecting subscriber traffic packets with the data inspection logic entity. A pre-rating classification table associated with the data inspection logic is provisioned either with at least one of table entries for static or slowly changing rating aspects of traffic applications or both a table entry for static or slowly changing rating aspects of traffic applications and a table entry identifying a dynamic changing rating aspects of a traffic application. A server with a rating engine is also provided. A query is made by the data inspection logic to the pre-rating table as to the treatment of rating aspects of traffic applications of subscriber traffic. From this the data inspection logic either obtains a rate value from the pre-rating classification table from one of the table entries for static or slowly changing rating aspects of traffic applications or obtains an indication from an entry identifying a dynamic changing rating aspects of traffic applications directing the data inspection logic to query the rating engine.

The data inspection logic may then query the server as to dynamic changing rating aspects of traffic applications. The server then provides a correct valuation for the dynamic changing rating aspects of traffic applications.

The packet inspection engine according to the invention is part of an MSDS as an intelligent service layer between the mobile transport network and the mobile Business Support Systems (BSS) infrastructure. By controlling subscriber data sessions and performing detailed layer 7 analysis of subscriber traffic, the solution according to the invention enables operators to effectively control prepaid subscribers, to charge based on content and event type, and to support flexible business models including revenue sharing and reverse charging with content partners.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

FIG. 1 is a schematic view of a Mobile Services Delivery System according to the invention;

FIG. 2 is a schematic view of the packet inspection system of the invention;

FIG. 3 is a flow diagram showing basic features of the process of the invention.

### DESCRIPTION OF THE PREFERRED EMBODIMENT

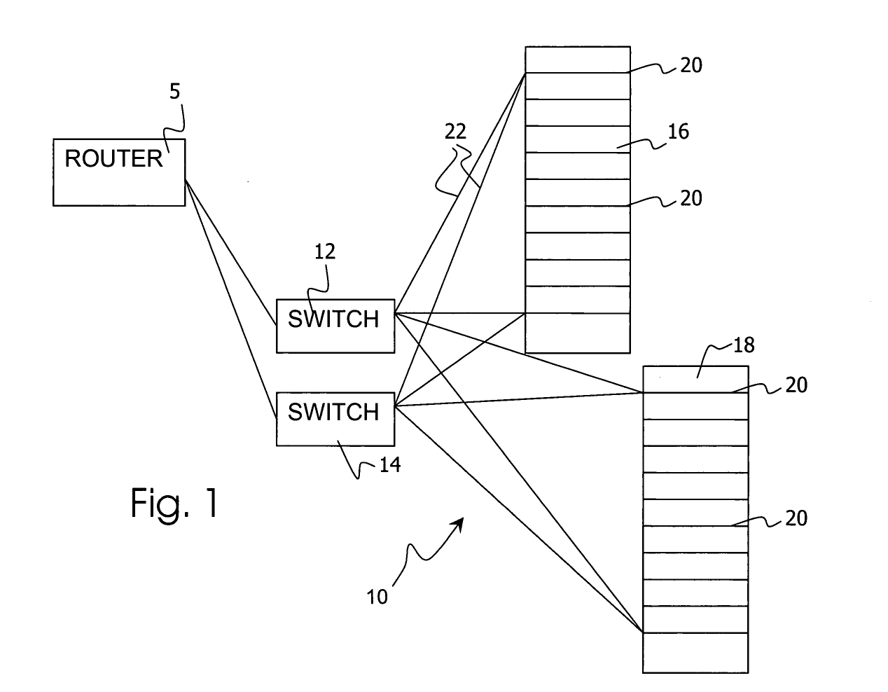

Referring to the drawings in particular, the invention may be provided by a Mobile Services Delivery System (MSDS) 10 as shown in FIG. 1. The system 10 is connected to a router or switching device 5. The router 5 receives and sends packets to subscribers 7 and receives and sends packets to the Internet 9 or other sources of content. The router 5 directs packet traffic to the MSDS 10 via a switch 12 or via a set of switches 12 and 14. The switches 12 and 14 may be ethernet switches (e.g., gigabit Ethernet). In the embodiment shown packets are inspected and/or processed with the system inspection logic 30 using application processing engines provided by a chassis 16 with a plurality of processing blades 20. Each processing blade 20 is connected to each of the switches 12, 14 via gigabit Ethernet connections 22 or other similar connection. The preferred embodiment employs multiple Intel processor blades 20 in an Intel compact PCI chassis 16. In the embodiment of FIG. 1, a further chassis 18 is provided with further processor blades 20. Other and further processing capabilities may be provided as needed based on the particular processing situation encountered.

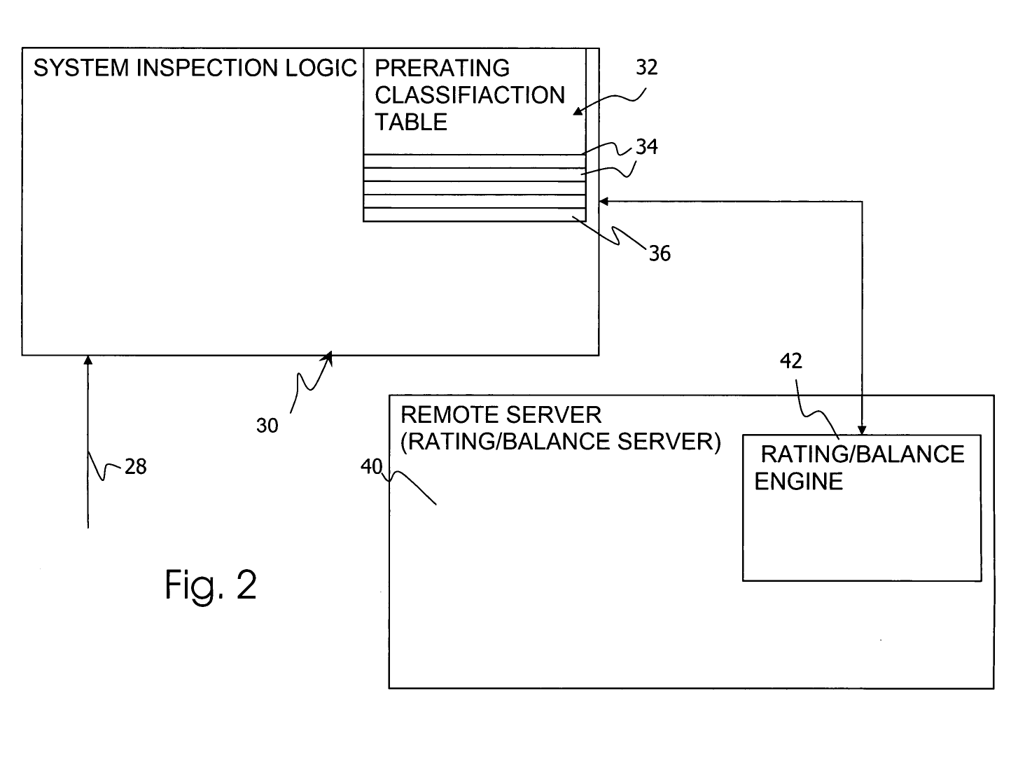

FIG. 2 shows the a logical embodiment of the MSDS 10 using the features of the invention. The MSDS 10 includes system inspection logic 30. The system inspection logic 30 monitors subscriber traffic with the MSDS 10 acting as a single point for the creation and delivery of mobile data service policies including policies for access networks (roaming, home, 2.5G, 3G, WLAN), charging (postpaid, prepaid, content, event, promotion, time of day), and forwarding (content control, content or event limits). Operators can use the MSDS 10 to create dynamic policies based on the instantaneous subscriber state.

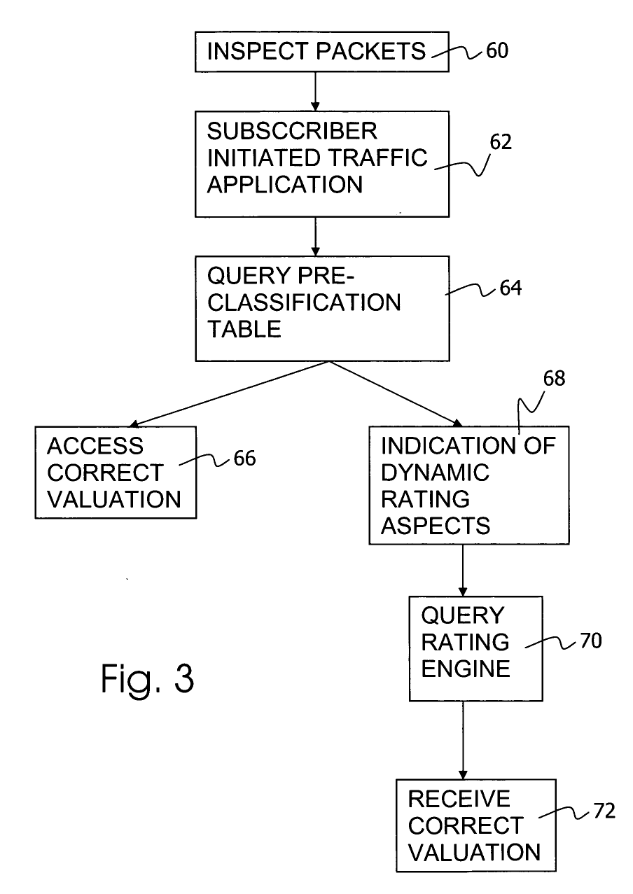

The MSDS 10, according to the invention, is able to deliver the best of both the systems that examine content and rate it according to tables/rules configured on the data plane component and the systems that examine content and use a full power BSS rating engine for the rate for the content. As shown in FIG. 2, the system inspection logic 30 is provided with pre-rating tables 32. The system inspection logic 30 inspects packets of a subscriber traffic packet flow 28. The inspection of packets (indicated at 60 in FIG. 3) considers traffic applications of the subscriber traffic packet flow 28 to determine a correct valuation for the traffic applications. Upon the subscriber initiating or requesting a traffic application (indicated at 62 in FIG. 3), the system inspection logic 30 queries (indicated at 62 in FIG. 3) the pre-rating classification table 32. The pre-rating classification table 32 has various table entries including table entries 34 for static or slowly changing rating aspects of traffic applications. These entries are updated (as with existing solutions) using provisioning systems. In addition, certain table entries 36 are marked to indicate that the pre-rating, for content matching these classifications, is more dynamic in value. The entry 36 identifies dynamic changing rating aspects of traffic applications to the system inspection logic 30. In response to the query 64 as to the particular subscriber traffic application, the inspection logic 30 either obtains data (indicated at 66 in FIG. 3) from an entry 34 of the pre-rating classification table 32 representing the correct valuation of the traffic application or obatins data (indicated at 68 in FIG. 3) from an entry 36 of the pre-rating classification table 32 indicating that the subscriber traffic application has dynamic rating aspects, directing the inspection logic 30 to query a rating engine 42.

The system inspection logic 30 queries a rating engine or BSS rating/balance engine 42. The rating/balance engine 42 may be part of a Remote Authentication Dial-In User Server (RADIUS) or remote server 40 (see FIG. 2). The BSS rating/balance engine 42 provides the correct valuation in response to the querry. This rating/balance engine 42 can be used to rate content with dynamic aspects including content rated according to subscriber activity. The information provided by the system inspection logic 30 to the rating/balance engine 42 contains all necessary identifying characteristics of the content as well as the identity of the subscriber accessing the content so as to enable the most flexible rating behavior. The identifying characteristics may include the type and size of the event, the URL or URI, for MMS or email the source and destination address, and/or other characteristics of the event. The valuation or rating provided by the server 40 is based on information about the content such as how new the content is or how popular it is and the valuation is also based on information about the subscriber's service (based on the agreement with the operator) and the subscriber's properties.

The rating system and method of the MSDS 10 according to the invention, is described further based on the following examples.

In a first example, the subscriber has established a data connection through the MSDS system 10 and is receiving Multimedia Messaging Service (MMS) messages. This service according to the example is normally free. However, some MMS applications are not free. Some of the applications are well defined and basically static as to price such as 888 service. For the messages (or applications) having well defined and basically static rating aspects the system inspection logic 30 queries the table 32 (indicated at 64 in FIG. 3) to determine the appropriate prepaid rate. As the rating aspects or value changes slowly the corresponding rating information entries 34 in the table 32 can be updated as mentioned. The system inspection logic 30 accesses the information at 66. The table 34 provides the correct valuation for the service based on a relevant entry 34.

For other applications, for example a traffic monitoring service, for example accessed with a number 617-000-0000 (referred to as the 617 service), the pricing of the service may depend on the time of day (in which rush hour is more expensive). The system inspection logic 30 consults with the tables 32 and accesses the entry 36 from the table 32. From this the system inspection logic 30 determines that the rate is dynamic (indicated at 68 in FIG. 3) relating to dynamic rating aspect entry 36. The system inspection logic 30 then directs an inquiry (indicated at 70 in FIG. 3) as to the 617 service to the BSS rating engine 42. The BSS rating engine 42 in turn provides a rating for the 617 service content based on identifying and charging relevant characteristics of the service interaction. In making the query 70, the system inspection logic 30 provides to the rating engine 42 the necessary identifying and/or charging relevant characteristics of the content as well as the identity of the subscriber accessing the content. These characteristics may include the originating address and destination address of the MMS message, the type(s) and size of the contents, and other header information included in the messages. The rating/balance engine 42 may access the balance of the subscriber (depending upon the properties of the subscriber). The rating/balance engine 42 provides the system inspection logic 30 with an answer as to whether or not the subscriber is permitted to access the activity including whether or not the subscriber has sufficient balance. The rating/balance engine 42 of the server 40 may also return a reservation of credit to the system inspection logic 30 to use for the activity. At the end of the activity the system inspection logic 30 can notify the rating/balance engine 42 of the successful completion of the service and the rating/balance engine 42 will adjust the subscriber's balance by the indicated amount. In this example the prepaid system, namely the rating/balance engine 42 reserves the subscriber's credit for the 617 service activity. The server 40 then notifies the system inspection logic 30 that 617 service may proceed. After the service is completed, the system inspection logic 30 notifies the rating/balance engine 42 of the completion of the MMS transfer. The rating/balance engine 42 decrements the subscribers balance by an amount. This reduction is typically to the amount reserved (this may be the case where the rating/balance engine 42 reserves the exact amount or this may be the case where the MSDS 10 is decrementing from a delegated credit pool).

In another, the subscriber has established a data connection through the MSDS 10 according to the present invention. The subscriber is a prepaid subscriber, and has a reserve of 1,000 credits from his balance at the balance manager/rating engine 42. As the subscriber sends (or requests) and receives traffic which is rated with stable values, the system inspection logic 30 queries the table 32 (indicated at 64 in FIG. 3) and is provided with the correct value (indicated at 64 in FIG. 3) and determines how much of the reserve to consume.

The subscriber then initiates a transfer of a video clip from “Hot New Artist” who will be touring in the area. The operator and content provider have arranged the clips so that recent clips are in a special “dynamic” directory. When the system inspection logic 30 inspects packet traffic and detects Real Time Streaming Protocol (RTSP) or Hypertext Transfer Protocol (HTTP) requests for this clip it queries the pre-rating table (indicated at 64 in FIG. 3) and is provided with an indication (indicated at 70 in FIG. 3) to query the rating system for the value of this event. If this is event rated (price defined by the clip, and it is higher because this artist is coming soon) then there are three possible answers from the rating engine 42 as to valuation and use of the credits:

1) The rating/balance server system 40 can return an indication that this event involves some number of credits (15 credits). The system inspection logic 30 allows the transfer and decrements the reservation by 15 credits.

2) The rating/balance server system 40 could alternatively indicate to the system inspection logic 30 that the rating/balance server system 40 will manage the credits for this as a separate activity. The system inspection logic 30 allows the transfer to proceed, and reports back to the rating/balance server system 40 upon completion.

3) The rating/balance server system 40 could alternatively indicate to the system inspection logic 30 not to allow the transfer. The system inspection logic 30 would then not allow the transfer to proceed.

For content which has a dynamic value and is rated by volume rather than event, there are two more possibilities. The operator using the MSDS 10 may apply volume charging for video channels, and the operator may adjust the price every day based upon what is more popular. In this case the subscriber begins an RTSP transfer of the video stream. The system inspection logic 30 inspects packet traffic and queries the pre-rating table (indicated at 64 in FIG. 3) and is provided with an indication (indicated at 70 in FIG. 3) to query the rating system for the value. The rating system may reply (indicated at 72 in FIG. 3) as follows:

1) A response 72 is provided from the rating/balance server system 40 indicating that this stream is charged at a particular rate (e.g., 3-credits per kilo-byte). The system inspection logic 30 then decrements the existing reserve by 3 credits as each kilo-byte is transferred.

A response 72 is provided from the rating/balance server system 40 indicating that this stream is charged at a particular rate (e.g., 3 credits per kilo-byte), and that a separate allocation of credit is to be used for this, because the subscriber (or operator) wants to manage the allocation of money or credit for this high priced activity. The initial response 72 includes 100 credits for the stream. The system inspection logic 30 creates a separate reservation or reserve using these 100 credits. The system inspection logic 30 decrements this special reserve by 3 credits each time one kilo-byte is transferred to the subscriber. When the separate reservation runs low, the system inspection logic 30 asks the rating/balance engine 42 of system 40 for additional credit for this separate reserve. When the transfer finishes, any credits left in the separate reserve are returned to the rating/balance manager system 40.

While a specific embodiment of the invention has been shown and described in detail to illustrate the application of the principles of the invention, it will be understood that the invention may be embodied otherwise without departing from such principles.

What is claimed is:

1. A packet inspection system, the system comprising:
data inspection logic inspecting subscriber packet traffic;
a pre-rating classification table including one or more entries for static or slowly changing rating aspects of traffic applications and at least one entry identifying a dynamic changing rating aspects of a traffic application;
a server with a rating engine, said data inspection logic making an query to said pre-rating table as to the treatment of rating aspects of traffic applications and either receiving a rate value from said pre-rating classification table from one of said table entries for static or slowly changing rating aspects of traffic applications or receiving an indication from said at least one entry identifying a dynamic changing rating aspects of traffic applications directing said data inspection logic to query said rating engine, said data inspection logic then querying said server as to dynamic changing rating aspects of traffic applications and said server providing said data inspection logic with a correct valuation for said dynamic changing rating aspects of traffic applications.

2. A packet inspection system according to claim 1, wherein said server with a rating engine is a Remote Authentication Dial-In User Server (RADIUS).

3. A packet inspection system according to claim 1, wherein said data inspection logic queries said server including providing subscriber status data to said server.

4. A packet inspection system according to claim 1, wherein said rate value depends on one or more of time of subscriber use, subscriber roaming state and a service package assigned to the subscriber.

5. A packet inspection system according to claim 1, wherein the packet inspection system periodically replaces table entries or replaces table entries as needed with new or updated table entries.

6. A packet inspection system according to claim 1, wherein said rating engine is a rating and balance engine and upon receiving a query from the data inspection logic said rating and balance engine determines whether or not the subscriber is permitted to access the activity.

7. A packet inspection system according to claim 6, wherein said rating and balance engine considers whether or not the subscriber has a balance of credit wherein said rating and balance engine returns a reservation of credit to the data inspection logic to charge the activity against and at the end of the activity the data inspection logic notifies the rating and balance engine of the successful completion of the service and an indication of an amount of the reserve that the subscriber's balance must be adjusted by.

8. A packet inspection system according to claim 1, wherein said data inspection logic is formed by one or more processors connected to said subscriber traffic by one or more switch.

9. A packet inspection system according to claim 8, further comprising a router, wherein said data inspection logic is at a first location with said one or more processors and said one or more switch and said server with a rating engine is at a remote location, said server being connected to said one or more processors and said one or more switch via said router.

10. A packet inspection method, comprising the steps of:
providing a data inspection logic entity and inspecting subscriber traffic packets with the data inspection logic entity;
providing a pre-rating classification table associated with the data inspection logic, entity;
provisioning the pre-rating classification table with at least one of table entries for static or slowly changing rating aspects of traffic applications and both a table entry for static or slowly changing rating aspects of traffic applications and a table entry identifying a dynamic changing rating aspects of a traffic application;
providing a server with a rating engine;
making a query by the data inspection logic to the pre-rating table as to the treatment of rating aspects of traffic applications of subscriber traffic and either obtaining a rate value from said pre-rating classification table from one of said table entries for static or slowly changing rating aspects of traffic applications or obtaining an indication from an entry identifying a dynamic changing rating aspects of traffic applications directing said data inspection logic to query the rating engine.

11. A packet inspection method according to claim 10, further comprising the steps of:
querying the server with the data inspection logic as to dynamic changing rating aspects of traffic applications;
providing the data inspection logic from the server with a correct valuation for the dynamic changing rating aspects of traffic applications.

12. A packet inspection method according to claim 10, further comprising provisioning the pre-rating table with new table entries or updated table entries.

13. A packet inspection method according to claim 11, further comprising providing the server and rating engine as a Remote Authentication Dial-In User Server (RADIUS).

14. A packet inspection method according to claim 11, wherein the rating engine is a rating and /balance engine providing the correct valuation based on prepaid credits (stored value) of the subscriber with incrementing and decrementing to take place based on the use by the subscriber.

15. A packet inspection method according to claim 11, wherein the rating engine is a rating and balance engine the rating engine rating application content according to one or more of event occurrence, traffic volume, or duration of activity.

16. A packet inspection method according to claim 11, wherein the rating engine is a rating and balance engine and the system inspection logic provides the rating and balance engine with all necessary identifying characteristics of the content of the application to be rated as well as the identity of the subscriber accessing the content so as to enable the most flexible rating behavior.

17. A packet inspection method according to claim 11, wherein said rating engine is a rating and balance engine and upon receiving a query from the data inspection logic said rating and balance engine determines whether or not the subscriber is permitted to access the activity.

18. A packet inspection method according to claim 17, wherein said rating and balance engine returns a reservation of credit to the data inspection logic to charge the activity against and at the end of the activity the data inspection logic notifies the rating and balance engine of the successful completion of the service and an indication of an amount of the reserve that the subscriber's balance must be adjusted by.

19. A packet inspection method according to claim 17, wherein said data inspection logic is formed by one or more processors connected to said subscriber traffic by one or more switch at a location with said one or more processors and said server with a rating engine is at a remote location, said server being connected to said one or more processors and said one or more switch via said router.

20. A packet inspection system for inspecting subscriber packet traffic, the system comprising:
a packet inspection engine at a location, the inspection engine being connected to subscriber packet traffic for inspection thereof;
a pre-rating table associated with said packet inspection engine, said pre-rating table having table entries relating to one or more of packet traffic applications having a static rating aspect and packet traffic applications having a dynamic rating aspect; and
a server remote from said location having a rating engine for rating traffic applications, said packet inspection engine consulting said pre-rating table for rating traffic applications for subscribers and either obtaining a rating for a subscriber's traffic application or querying said server if said a subscriber's traffic application is associated with a table entry indicating a packet traffic application having a dynamic rating aspect.
